(19) United States
(12) Patent Application Publication
(10) Pub. No.: US 2016/0314808 A1
(43) Pub. Date: Oct. 27, 2016

(54) HEAD ACTUATOR ASSEMBLY, FLEXIBLE PRINTED CIRCUIT UNIT, AND DISK DRIVE WITH THE SAME

(71) Applicant: KABUSHIKI KAISHA TOSHIBA, Tokyo (JP)

(72) Inventor: Hiroyuki IWAHARA, Kawasaki Kanagawa (JP)

(21) Appl. No.: 15/015,740

(22) Filed: Feb. 4, 2016

Related U.S. Application Data
(60) Provisional application No. 62/152,244, filed on Apr. 24, 2015.

(51) Int. Cl. G11B 5/48

(52) U.S. Cl. CPC G11B 5/4833; G11B 5/486

(57) ABSTRACT

A head actuator assembly includes a carriage assembly including a bearing portion, first and second suspension assemblies extending from the bearing portion and each configured to support a head, and wire traces provided on each of the first and second the suspension assemblies and each including one end connected to a respective head and a connection end portion having connection terminals, and a flexible printed circuit board unit electrically connected to the wire traces through the connection terminals on both of opposing sides of the carriage assembly.

### CROSS-REFERENCE TO RELATED APPLICATIONS

This application is based upon and claims the benefit of priority from U.S. Provisional Application No. 62/152,244, filed on Apr. 24, 2015, the entire contents of which are incorporated herein by reference.

### FIELD

Embodiments described herein relate generally to a head actuator assembly, a flexible printed circuit (FPC) unit, and a disk device.

### BACKGROUND

A magnetic disk drive generally comprises a magnetic disk accommodated in a housing, a spindle motor configured to support and rotate the magnetic disk, a carriage assembly configured to support magnetic heads, a voice coil motor configured to drive the carriage assembly, a flexible printed circuit (to be referred to as FPC hereafter) board unit, etc.

The carriage assembly comprises a bearing portion rotatably mounted on the housing and arms extending from the bearing portion, and the magnetic head is attached to each of the arms via respective suspensions. The FPC unit includes a base section fixed to the housing, on which electronic parts, a connector, etc., are mounted, and a belt-shaped relay portion extending from the base section to the vicinity of the bearing portion and having curved portions. The base section and the belt-shaped relay portion are integrated as one unit. An extended end portion of the relay portion is formed into a connecting portion, and the connecting portion is fixed (by, for example, a screw) to a side surface of the bearing portion of the carriage assembly.

Meanwhile, a belt-shaped wire trace is provided on each suspension. A tip portion of the wire trace is electrically connected to the magnetic head. At a proximal end of the wire trace, a connection end comprising contact terminals is formed, and the connection end is joined to the connecting portion of the FPC unit. Each contact terminal is electrically connected to the respective magnetic heads through the wire trace.

In recent years, the magnetic head of a magnetic disk device has been formed to comprise a number of elements each for controlling the dynamic fly-height (DFH) of read operations and the DFH of write operations separately, and controlling a dual stage actuator (DSA), and for two-dimensional magnetic recording (TDMR), etc. Accordingly, the number of wire traces and connection terminals has increased.

However, it is difficult to expand the area of the connecting portion according to the increase in the number of connection terminals. Therefore, when the number of connection terminals increases, it is necessary to narrow the pitch of connection terminals, and decrease the width of signal lines in the wire traces. However, the pitch of terminals and the width of signal lines have already been narrowed and further narrowing would compromise signal quality and reliability.

### BRIEF DESCRIPTION OF THE DRAWINGS

FIG. 1 is a perspective view of a hard disk drive (HDD) according to an embodiment, with its top cover removed;

FIG. 2 is a perspective view of a head actuator assembly of the HDD;

FIG. 3 is a perspective view of the head actuator assembly as viewed from a side opposite to that of FIG. 2;

FIG. 4 is a perspective view of a lower surface side (head side) of a suspension assembly in the head actuator assembly;

FIG. 5 is a perspective view of an upper surface side (opposite side to the head side) of the suspension assembly;

FIG. 6 is a side view of a connection portion between an FPC assembly of the head actuator assembly and the suspension assembly;

FIG. 7 is a perspective view of a flexible printed circuit board of the FPC assembly.

### DETAILED DESCRIPTION

Various embodiments will be described hereinafter with reference to the accompanying drawings. In general, according to one embodiment, a head actuator assembly comprises a carriage assembly comprising a bearing portion, first and second suspension assemblies extending from the bearing portion and each configured to support a head, and wire traces provided on each of the first and second suspension assemblies and each comprising one end connected to a respective head and a connection end portion comprising connection terminals, and a flexible printed circuit board unit electrically connected to the wire traces through the connection terminals on both of opposing sides of the carriage assembly.

As a disk device, a hard disk drive (HDD) according to an embodiment will now be described in detail.

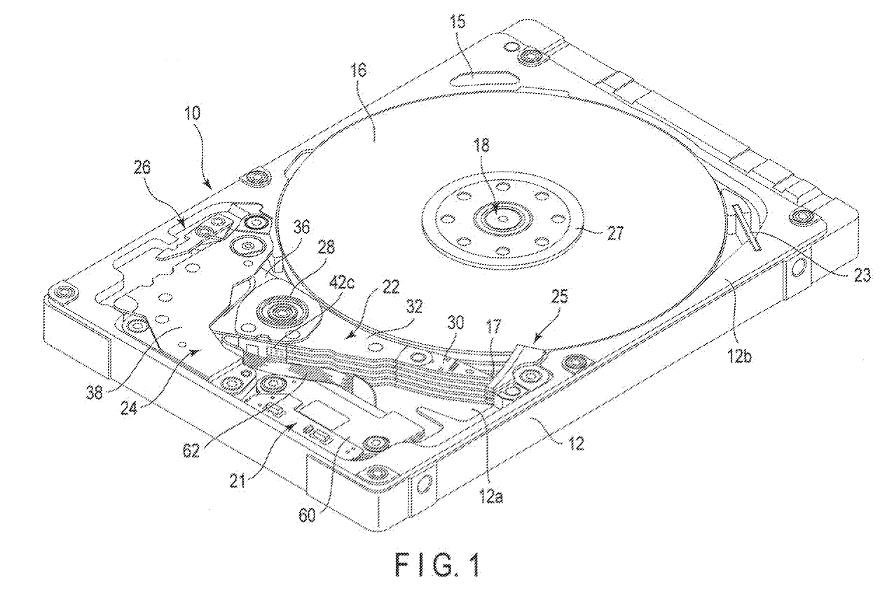

FIG. 1 shows an internal structure of the HDD with its top cover removed. As shown in FIG. 1, the HDD comprises a housing 10. The housing 10 comprises abase 12 having a rectangle box shape whose upper surface is opening and a top cover (not shown) fixed to the base 12 with screws to close an upper end opening of the base 12. The base 12 comprises a bottom wall 12a of a rectangular shape and a side wall 12b rising along the edge of the bottom wall 12a.

In the housing 10 are arranged, for example, four magnetic disks 16 as recording media, and a spindle motor 18 as an actuator configured to support and rotate the magnetic disks 16. The spindle motor 18 is provided on the bottom wall 12a. Each magnetic disk 16, for example, is formed to have a diameter of 65 mm (2.5 inches) and comprises a magnetic recording layer on an upper surface (one side) and a lower surface (another side). The magnetic disks 16 are coaxially fitted with a hub (not shown) of the spindle motor 18 and also clamped with a clamp spring 27, thus fixed to the hub. With this structure, the magnetic disks 16 are supported in parallel to the bottom wall 12a of the base 12. The magnetic disks 16 are rotated at a particular speed by the spindle motor 18.

In the housing 10 are provided magnetic heads 17 configured to record and read data on and from the magnetic disks 16 and a carriage assembly 22 configured to support the magnetic heads 17 movable over the magnetic disk 16, respectively. Further provided in the housing 10 are a voice coil motor (to be called VCM hereinafter) 24 configured to rotate the carriage assembly 22 and position the magnetic heads 17, a ramp load mechanism 25 configured to retain the magnetic heads 17 at an unloading position away from the respective magnetic disk 16 when the magnetic heads 17 move to the outermost circumference of the magnetic disk 16, a latch mechanism 26 configured to retain the carriage assembly 22 in an evacuation position when a shock etc. act on the HDD, and a flexible printed circuit board (FPC) unit 21 in which electronic parts such as conversion connectors are mounted. The carriage assembly 22 and the FPC unit 21 form the head actuator assembly. Note that the latch mechanism 26 is not necessarily limited to a mechanical type, but a magnetic latch may be used as well.

A printed circuit board (control circuit board), although not illustrated, is screwed to an external surface of the bottom wall 12a of the base 12. The printed circuit board is configured to control operation of the VCM 24 and the magnetic heads 17 via the FPC unit 21. In the vicinity of the side wall 12b of the base 12, a circulation filter 23 configured to capture the dust generated in the housing by operation of movable members is provided on an outer side to the magnetic disks 16. Further, in the vicinity of the side wall 12b of the base 12, an air filter 15 configured to capture dust from the air which flows into the housing 10 is provided.

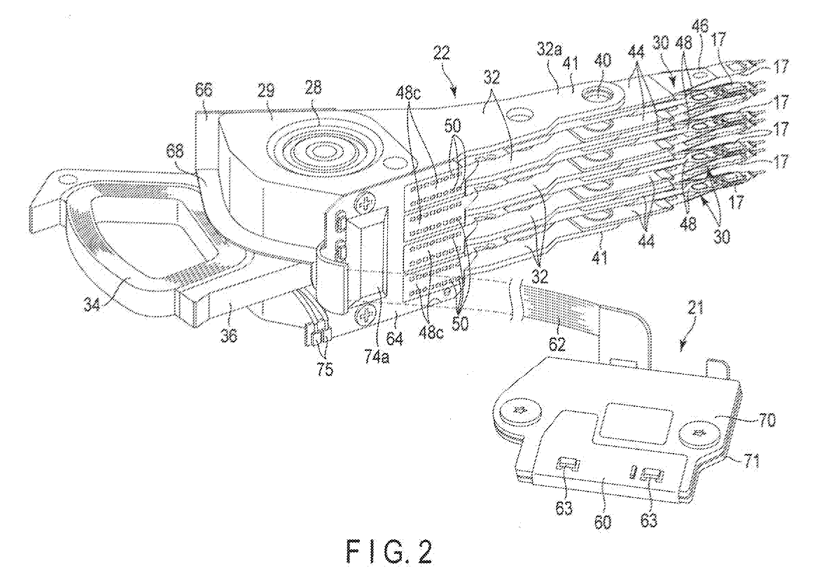

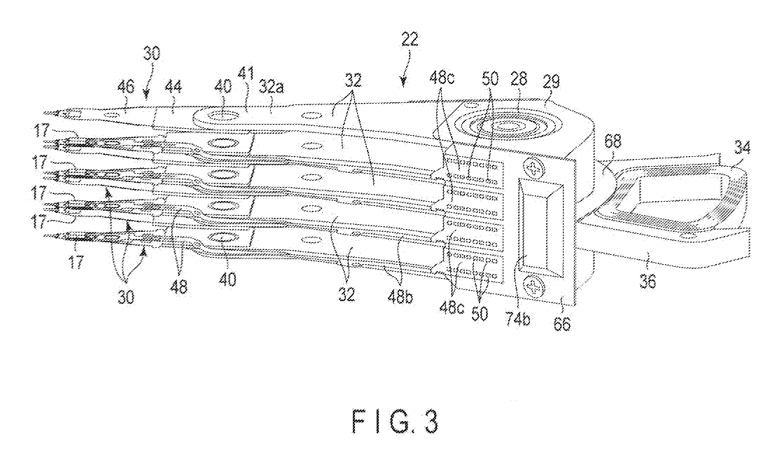

FIG. 2 is a perspective view of the head actuator assembly including the carriage assembly and the FPC unit from one side, and FIG. 3 is another perspective view of the carriage assembly from an opposite side to that of FIG. 2. As shown in FIGS. 1 to 3, the carriage assembly 22 comprises a rotatable bearing unit 28, a sleeve 29 accommodating the bearing unit 28, five arms 32 extending from the sleeve 29, suspension assemblies 30 attached to the respective arms 32, and the magnetic heads 17 supported by the respective suspension assemblies 30. The bearing unit 28 comprises an axis standing on the bottom wall 12a of the base 12 near the outer circumferences of the magnetic disks 16, and bearings attached to the axis. The bearings of the bearing unit 28 are fitted in the sleeve 29 of cylindrical shape. With this structure, the carriage assembly 22 is supported on the bottom wall 12a to be rotatable around the axis of the bearing unit 28.

The five arms 32 extend from the sleeve 29 in the same direction and are placed parallel to each other with a gap therebetween. Each arm 32 comprises a distal end portion 32a on the side of the extending end, and on upper and lower sides of the distal end portion 32a, a bearing surface 41 with a circular caulked hole (swage hole) 40 is formed.

In this embodiment, the five arms 32 are assembled together with the sleeve 29 as one integral unit to form an actuator block or E block. Each arm 32 is formed of, for example, stainless steel or aluminum having a slender plate shape, and is extended from the sleeve 29 in a direction perpendicular to the axis of the bearing unit 28. Note that the arms 32 may be set independent of each other, on the bearing unit 28 to form layers.

The carriage assembly 22 comprises a holding frame 36 extending in a direction opposite to the arms 32 from the sleeve 29, and with the holding frame 36, a voice coil 34 which forms a part of the VCM 24 is supported. As shown in FIG. 1, the voice coil 34 is located between a pair of yokes 38, one of which is fixed on the base 12. The yokes 38 and a magnet fixed to one of the yokes 38 form the VCM 24.

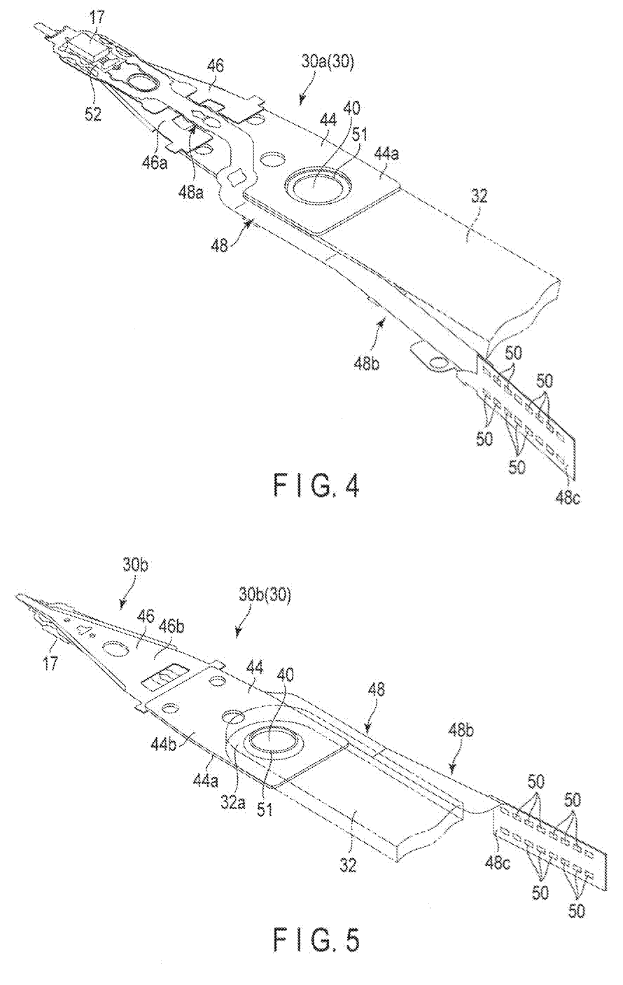

FIGS. 4 and 5 are perspective diagrams showing the suspension assembly viewed from a lower surface side (head side) and an upper surface side (opposite to head side), respectively.

In this embodiment, the carriage assembly 22 includes eight suspension assemblies 30 and all the suspension assemblies 30 have the same structure. Each suspension assembly 30 includes an up-head (second) suspension assembly 30a configured to support the magnetic head 17 upward (in a second direction) as shown in FIG. 4, and a down-head (first) suspension assembly 30b configured to support the magnetic head 17 downward (in a first direction opposite to the second direction) as shown in FIG. 5. The up-head suspension assembly 30a and the down-head suspension assembly 30b are prepared from suspension assemblies 30 of the same structure by arranging them to face upper and lower sides, respectively.

As shown in FIGS. 4 and 5, the suspension assemblies 30 each comprise a base plate 44 of substantially a rectangular shape, a load beam 46 of a slender flat spring, and a slender belt-shaped flexure (trace member) 48. The load beam 46 is fixed to the base plate 44 while a distal end portion overlaid on the end of base plate 44. The load beam 46 extends from the base plate 44, and is formed to be tapered toward its extended end. The base plate 44 and the load beam 46 are formed of stainless steel, for example. For example, the thickness of the base plate 44 is about 150 μm, and that of the load beam 46 is about 25 to 30 μm.

The base plate 44 comprises a first surface 44a and a second surface 44b. The base plate 44 comprises a circular opening in its proximal end portion, and a circular projection 51 around the circumference of the opening. The projection part 51 projects from the second surface 44b of the base plate 44. As shown in FIGS. 2 to 5, the base plate 44 is disposed so that the second surface 44b side of its proximal end portion meets the bearing surface 41 of the distal end portion 32a of the arm 32. The projection part 51 of the base plate 44 fitted into the caulked hole (the swage hole) 40 formed in the arm 32 and the projection 51 is caulked (is swaged), and thus the base plate 44 is fastened to the distal end portion 32a of the arm 32. The first surface 44a of the base plate 44 is located in a side opposing the surface of the magnetic disk 16.

The load beam 46 comprises a first surface 46a and a second surface 46b on an opposite side. The proximal end portion of the load beam 46 is fixed to the base plate 44 by placing the second surface 46b side to meet the first surface 44a side of the distal end portion of the base plate 44 and welding them together at places. The first surface 46a of the load beam 46 faces the surface of the magnetic disk 16. The proximal end portion of the load beam 46 is formed to have a width substantially equally to the width of the distal end portion of the base plate 44.

As shown in FIGS. 4 and 5, the flexure 48 of the suspension assembly 30 comprises a metal plate (lining layer) of stainless steel or the like, used as a base, an insulating layer formed on the metal plate, a conductive layer provided on the insulating layer to form a number of traces (wiring pattern) and a protective layer (insulating layer) configured to cover the conductive layer, made into a slender belt-shaped multilayer plate.

The flexure 48 comprises a distal end side portion 48a attached on the first surface 46a of the load beam 46 and the first surface 44a of the base plate 44, and a proximal end side portion 48b extending outward from the side edge of the base plate 44 and further extending to the proximal end portion of the arm 32 along the side edge of the base plate 44 and the arm 32. The flexure 48 attaches or welds pivotally by its metal plate side on the first surface 46a of the load beam 46, and on the first surface 44a of the base plate 44. The flexure 48 comprises a displaceable gimbal portion (elastic support portion) 52 at a distal end portion of the flexure 48 located above the load beam 46, and the respective magnetic head 17 is mounted on the gimbal portion 52. A part of the tracing line of the flexure 48 is electrically connected to the magnetic head 17.

The proximal end side portion 48b of the flexure 48 extends outward from the side edge of the base plate 44, and further to the proximal end of the arm 32 along this side edge and one side edge of the arm 32. A connection end portion 48c of the flexure 48 is formed in one end of the proximal end side portion 48b. The connection end portion 48c is formed into a slender rectangular shape. The connection end portion 48c is bent at right angles with respect to the proximal end side portion 48b, and is situated substantially perpendicularly with respect to the arm 32. A number of, for example, sixteen connection terminals (contact pads) 50 are provided in the connection end portion 48c. In this embodiment, the connection terminals 50 are lined in two rows of eight. The connection terminals 50 are connected to traces of the flexure 48, respectively. That is, the traces of the flexure 48 extend over substantially its entire length, with the ends on one side being electrically connected to the magnetic head 17 and the ends on the other side being connected to the connection terminals (contact pads) 50 provided in the connection end 48c.

As shown in FIG. 4, in the up-head suspension assembly 30a, the proximal end side portion 48b and the connection end 48c of the flexure 48 are located on the left side in a direction from the arm 32 toward the magnetic head 17 (the second side surface) of the arm 32. On the other hand, as shown in FIG. 5, in the down-head suspension assembly 30b, the proximal end side portion 48b and the connection end 48c of the flexure 48 are located on the right side in the direction from the arm 32 toward the magnetic head 17 (the first side surface) of the arm 32.

As shown in FIGS. 2 and 3, in the carriage assembly 22, the base plate 44 of the uppermost down-head suspension assembly 30b is fixed to the bearing surface 41 on the lower surface side of the distal end portion 32a of the uppermost arm 32. In each of the second, third, and fourth arms 32 from the top, the up-head suspension assembly 30a and the down-head suspension assembly 30b are fixed, respectively, to both of upper and lower bearing surfaces 41 of the distal end portion 32a. Further, the base plate 44 of the up-head suspension assembly 30a is fixed to the upper-surface side bearing surface 41 of the distal end portion 32a of the lowermost arm 32.

The eight suspension assemblies 30 extend from the five arms 32 and are arranged side by side with a particular gap therebetween while facing each other substantially parallel to each other. The suspension assemblies 30 form four down-head suspension assemblies 30b and four up-head suspension assemblies 30a. Each pair of the down head suspension assembly 30b and the up-head suspension assembly 30a are located parallel to each other with a particular gap therebetween so that the magnetic heads 17 supported by the suspension assemblies 30 face each other. The magnetic heads 17 are located to face, respectively, both sides of the corresponding magnetic disk 16.

The connection ends 48c of the four down-head suspension assemblies 30b are located in a lateral side (first side surface) of the carriage assembly 22. The connection ends 48c of the four up-head suspension assemblies 30a are located in the opposite lateral side (second side surface) of the carriage assembly 22.

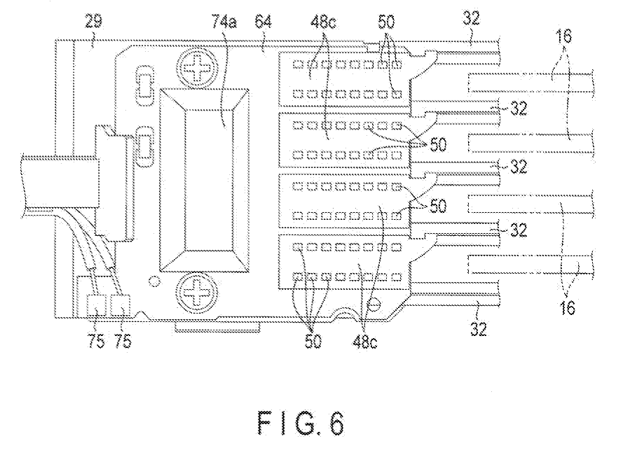

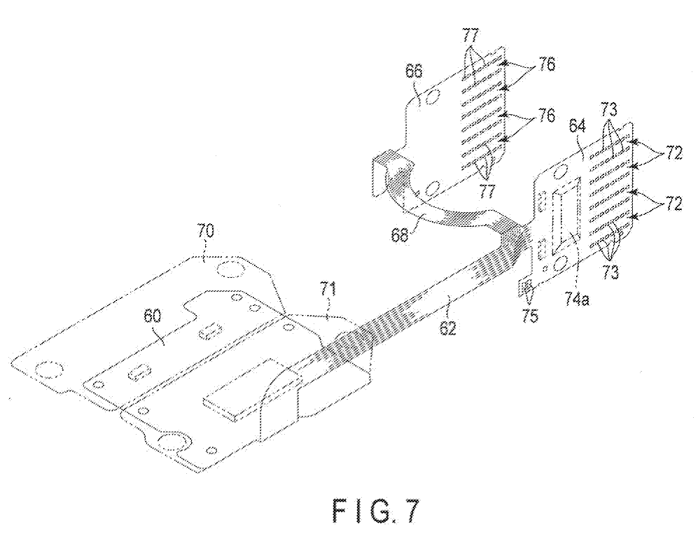

FIG. 6 is an expanded side view of the junction between the carriage assemblies and the FPC unit, and FIG. 7 is a perspective diagram showing the flexible printed circuit (FPC) board of the FPC unit.

As shown in FIGS. 2 and 7, the FPC unit 21 comprises a base portion 60 of substantially a rectangular shape, a slender belt-shaped relay portion 62 extending from one side edge (first side edge) of the base portion 60, a first junction 64 of substantially a rectangular shape, formed continuously to the distal end portion of the relay portion 62, a second junction 66 of substantially a rectangular shape, facing the first junction 64, and a bridge portion 68 extending from the distal end portion of the relay portion 62 to the second junction 66, which are integrated as one unit. The base portions 60, the relay portion 62, the first junction 64, the second junction 66, and the bridge portion 68 are formed of the flexible printed circuit board. The flexible printed circuit board comprises an insulating layer of polyimide or the like, a conductive layer provided on the insulating layer to form traces, a contact pad, and the like, and a protective layer configured to cover the conductive layer.

On one surface (outer surface) of the base portion 60, electronic parts such as conversion connectors (not shown) and a number of capacitors 63 are mounted, and electrically connected to traces not illustrated. On another side (inner surface) of the base portion 60, two metal plates 70 and 71 each functioning as a reinforcing board are attached. The base portion 60 is bent by 180 degrees at a junction portion between the metal plate 70 and the metal plate 71 so that the metal plates 70 and 71 are stacked and face each other. The base portion 60 is disposed on the bottom wall 12a of the housing 10, and is screwed to the bottom wall 12a with two screws. The conversion connectors on the base portion 60 are connected to the control circuit board provided in the bottom surface side of the housing 10.

The relay portion 62 extends from the first side edge of the base portion 60 substantially perpendicularly with respect to the first side edge, and changes its direction substantially by right angles further toward the carriage assembly 22.

The first junction 64 is formed into a rectangular shape which has a width substantially equal to the height (thickness) of the carriage assembly 22. The first junction 64 comprises four contact pad groups 72 corresponding to the connection end 48c of the suspension assembly 30. Each of the contact pad groups 72 comprises, for example, sixteen contact pads 73 arranged in two rows, and each contact pad 73 is electrically connected to the base portion 60 via a respective trace. A head IC (head amplifier) 74a is mounted on the first junction 64 and is connected to the contact pads 73 and to the base portion 60 via traces.

Further, the first junction 64 comprises two contact pads 75 to connect the voice coil 34. On an inner surface (rear surface) of the first junction 64, a lining board of, for example, aluminum is attached as a reinforcing board.

The first junction 64 comprising the above-described structure is fixed to the first side surface of the carriage assembly 22. Here, it is fixed by screw to a first side surface of the sleeve 29.

As shown in FIGS. 3 and 7, the second junction 66 of the FPC unit 21 is formed in substantially the same form and dimensions as those of the first junction 64. The second junction 66 comprises four contact pad groups 76 corresponding to the connection end portions 48c of the respective suspension assembly 30. Each of the contact pad groups 76 comprises, for example, sixteen contact pads 77 arranged in two rows, and each contact pad 77 is electrically connected to the base portion 60 via the bridge portion 68 and the relay portion 62. A head IC (head amplifier) 74b is mounted on the second junction 66 and is connected to the contact pads 77 and to the base portion 60 via respective traces. On an inner surface (rear surface) of the second junction 66, a lining board of, for example, aluminum is attached as a reinforcing board. The second junction 66 is fixed to the second side surface of the carriage assembly 22. Here, it is fixed by screw to a second side surface of the sleeve 29.

Thus, the first junction 64 and the second junction 66 are formed on both respective side surfaces of the carriage assembly 22 and arranged to interpose the bearing unit 28 and the sleeve 29 therebetween. The bridge portion 68 is built over on the holding frame 36 on the back end side of the sleeve 29.

As shown in FIGS. 2, 3 and 6, the connection end portions 48c of at least one of the eight suspension assemblies 30 of the four down-head suspension assemblies 30b are drawn out on the first side surface (right side surface) of the carriage assembly 22, and are joined to the first junction 64 of the FPC unit 21. In detail, the connection terminals 50 of each connection end portion 48c are joined electrically and mechanically with solder or the like, to the contact pads 73 of the corresponding contact pad group 72 of the first junction 64. Further, the traces of the voice coil 34 are connected to the contact pads 75 of the first junction 64.

The connection end portions 48c of at least one of the eight suspension assemblies 30 of the four up-head suspension assemblies 30a are drawn out on the second side surface (left side surface) of the carriage assembly 22, and are joined to the second junction 66 of the FPC unit 21. In detail, the connection terminals 50 of each connection end portion 48c are joined electrically and mechanically with solder or the like, to the contact pads 77 of the corresponding contact pad group 76 of the second junction 66.

With this structure, the eight magnetic heads 17 are electrically connected to the base portion 60 via the traces of the flexure 48, the connection end portions 48c, the first and the second junctions 64 and 66 of the FPC unit 21, the bridge portion 68, and the relay portion 62. Further, the base portion 60 is connected to the printed circuit board on the bottom surface side of the housing 10 through a conversion connector.

As shown in FIG. 1, while the carriage assembly 22 configured as described above is incorporated in the base 12, the bearing unit 28 is fixed at the lower end of an axis thereof to the base 12 and set to be substantially parallel to the spindle of the spindle motor 18. Each magnetic disk 16 is located between two suspension assemblies 30. When the HDD is in operation, the magnetic heads 17 attached to the suspension assembly 30 face the upper surface and the lower surface of the magnetic disk 16, respectively. The base portion 60 of the FPC unit 21 is fixed to the bottom wall 12a of the base 12.

According to the HDD and the head actuator assembly configured as described above, the first junction 64 and the second junction 66 of the FPC unit are disposed respectively on both side surfaces of the carriage assembly 22, and also at least one connection end portion 48c of the suspension assemblies 30 is joined to the first junction 64, while at least another connection end portion 48c is joined to the second junction 66. With this structure, the number of connection end portions 48c joined to one junction can be reduced. For example, in the embodiment, the number of the connection end portions 48c to be joined can be reduced in a half. Therefore, in the first junction 64 and the second junction 66, the area for joining one connection end portion 48c can be expanded, enabling to provide more connection terminals. At the same time, the area of the connection end on the suspension assembly side can also be expanded, enabling to provide even more connection terminals. Thus, multi-terminal junction can be achieved without increasing the area of each of the junctions 64 or 66, or narrowing the pitch between the connection terminals. Therefore, even in a case many terminals are formed, the connection end portions of the flexure and the junction of the FPC unit can be joined easily and certainly, enabling to maintain high signal quality and reliability.

While certain embodiments have been described, these embodiments have been presented by way of example only, and are not intended to limit the scope of the inventions. Indeed, the novel embodiments described herein may be embodied in a variety of other forms; furthermore, various omissions, and substitutions and changes in the form of the embodiments described herein may be made without departing from the spirit of the inventions. The accompanying claims and their equivalents are intended to cover such forms or modifications as would fall within the scope and spirit of the inventions.

The number of magnetic disks is not limited to four, but there may be three or less, or five or more. Further, the number of suspension assemblies and the number of magnetic heads may be adjusted according to the number of magnetic disks installed. The distribution of connection end portions of suspension assemblies to the first junction and second junction is not limited to by way of the configurations of the up-head and down-head types but they may be distributed arbitrarily. For example, suspension assemblies may be distributed to the first junction and the second junction for every one set.

What is claimed is:

1. A head actuator assembly comprising:
a carriage assembly comprising a bearing portion, first and second suspension assemblies extending from the bearing portion and each configured to support a head, and wire traces provided on each of the first and second suspension assemblies and comprising one end connected to a respective head and a connection end portion comprising connection terminals; and
a flexible printed circuit board unit electrically connected to the wire traces through the connection terminals on both of opposing sides of the carriage assembly.

2. The head actuator assembly of claim 1, wherein the flexible printed circuit board unit comprises a first connection junction provided on a first side of the carriage assembly, to which some of the connection terminals are joined, and a second junction provided on a second side of the carriage assembly opposite to the first side, to which some of the connection terminals are joined.

3. The head actuator assembly of claim 2, wherein
the first suspension assembly is configured to support a respective head in a first direction and the second suspension assembly is configured to support a respective head in a second direction opposite to the first direction.

4. The head actuator assembly of claim 3, wherein the connection end portion of the wire traces of the first suspension assembly is electrically connected to the first junction, and the connection end portion of the wire traces of the second suspension assembly is electrically connected to the second junction.

5. The head actuator assembly of claim 2, wherein each of the first and second junctions comprises contact pad groups to which the connection terminals of the corresponding connection end portion are respectively joined.

6. The head actuator assembly of claim 1, wherein the first suspension assembly and the second suspension assembly have the same structure.

7. The head actuator assembly of claim 1, wherein the connection terminals of the wire traces on each of the first and second suspension assemblies are arranged in two rows.

8. The head actuator assembly of claim 1, wherein the flexible printed circuit board unit comprises:
a base portion on which electronic components are mounted,
a relay portion extending from the base portion to the first junction, and
a bridge portion extending from the relay portion to the second junction, and the base portion, the relay portion, the bridge portion, the first and second junctions are formed into one unit by the flexible printed circuit board.

9. A flexible printed circuit board unit comprising:
a base portion on which electronic components are mounted;
a relay portion extending from the base portion;
a first junction at an end of the relay portion and comprising contact pads electrically connected to the base portion through the relay portion;
a second junction comprising contact pads; and
a bridge portion between the first and second junctions, the contact pads of the second junction being electrically connected to the base portion through the bridge portion and the relay portion.

10. The flexible printed circuit board unit of claim 9, wherein the relay portion has first wire traces that electrically connect the contact pads of the first junction to the base portion and second wire traces that electrically connect the contact pads of the second junction to the base portion through wire traces in the bridge portion.

11. The flexible printed circuit board unit of claim 9, wherein
the contact pads of each of the first and second junctions are arranged in two rows.

12. A disk device comprising:
a disk recording medium; and
a head actuator assembly.
including
a carriage assembly comprising a bearing portion, first and second suspension assemblies extending from the bearing portion and each configured to support a head, and wire traces provided on each of the first and second suspension assemblies and comprising one end connected to a respective head and a connection end portion comprising connection terminals; and
a flexible printed circuit board unit electrically connected to the wire traces through the connection terminals on both of opposing sides of the carriage assembly.

13. The disk device of claim 12, wherein the flexible printed circuit board unit comprises a first connection junction provided on a first side of the carriage assembly, to which some of the connection terminals are joined, and a second junction provided on a second side of the carriage assembly opposite to the first side, to which some of the connection terminals are joined.

14. The disk device of claim 13, wherein
the first suspension assembly is configured to support a respective head in a first direction and the second suspension assembly is configured to support a respective head in a second direction opposite to the first direction.

15. The disk device of claim 14, wherein the connection end portion of the wire traces of the first suspension assembly is electrically connected to the first junction, and the connection end portion of the wire traces of the second suspension assembly is electrically connected to the second junction.

16. The disk device of claim 13, wherein each of the first and second junctions comprises contact pad groups to which the connection terminals of the corresponding connection end portion are respectively joined.

17. The disk device of claim 12, wherein the first suspension assembly and the second suspension assembly have the same structure.

18. The disk device of claim 12, wherein the connection terminals of the wire traces on each of the first and second suspension assemblies are arranged in two rows.

19. The disk device of claim 12, wherein the flexible printed circuit board unit comprises:
a base portion on which electronic components are mounted,
a relay portion extending from the base portion to the first junction, and
a bridge portion extending from the relay portion to the second junction, and the base portion, the relay portion, the bridge portion, the first and second junctions are formed into one unit by the flexible printed circuit board.

20. The disk device of claim 19, wherein the relay portion has first wire traces that electrically connect the contact pads of the first junction to the base portion and second wire traces that electrically connect the contact pads of the second junction to the base portion through wire traces in the bridge portion.
